(19) United States
(12) Patent Application Publication
(10) Pub. No.: US 2018/0105733 A1
(43) Pub. Date: Apr. 19, 2018

(54) EARLY VISCOSITY ENHANCEMENT OF GELLED OIL

(71) Applicant: SCHLUMBERGER TECHNOLOGY CORPORATION, Sugar Land, TX (US)

(72) Inventors: Blake McMahon, Sugar Land, TX (US); Bruce MacKay, Sugar Land, TX (US)

(21) Appl. No.: 15/294,823

(22) Filed: Oct. 17, 2016

(51) Int. Cl. C09K 8/64; C09K 8/565; C09K 8/52; E21B 43/26

(52) U.S. Cl. CPC C09K 8/64; C09K 8/565; C09K 8/52; E21B 43/267; C09K 2208/26; C09K 2208/30; E21B 43/26

(57) ABSTRACT

A method of increasing the viscosity of a gelled organic-based fluid is disclosed. The method includes forming the gelled organic-based fluid by combining an organic solvent, an alkaline agent in the form of particles present in the gelled organic-based fluid in an amount from about 0.001 to about 0.02 pounds per gallon of the gelled organic-based fluid, a gelling agent, and a metal crosslinker. The gelled organic-based fluid having a viscosity which is greater than a viscosity of an equivalent gelled organic-based fluid not including the alkaline agent.

### FIELD

The invention relates to gelled oils used in treating subterranean formations. More particularly, it relates to gelled oils used in fracturing, sand control, frac packing, pipe cleanup, diversion, coiled tubing cleanout and other well services in the oilfield. Most particularly, it relates to a method of enhancing early viscosity enhancement and breaking the viscosity of gelled oils using a second alkaline agent.

### BACKGROUND

The statements in this section merely provide background information related to the present disclosure and may not constitute prior art.

Gelled liquid hydrocarbon fluids have been utilized in a variety of treatments for subterranean formations penetrated by well bores, including stimulation activities such as fracturing and/or gravel packing. Such hydrocarbon fluids must have a sufficiently high viscosity to generate a fracture of sufficient dimensions and also to carry the proppant particles into the fracture. Hydrocarbon fluids are frequently gelled by use of phosphate containing gelling agents, particularly phosphate acid ester gelling agents. These agents have been popular because of their effectiveness and comparatively low cost.

One aspect of well treatment processes is the “cleanup”, e.g., returning and removing used fluid from the well after the treatment has been completed. Returned fluids are also useful to carry and remove waste materials, excess proppant and the like from the well. Techniques for promoting cleanup often involve reducing the viscosity of the treatment fluid as much as practical so that it will more readily flow toward the wellbore. This is called “breaking” the fluid. Breaking agents, or “breakers” are specific to the type of treatment fluid being used. Gel breakers are commonly used for conventional polymer based fluids used in stimulation and other activities since leaving such a high viscosity fluid in the formation would result in a reduction of the formation permeability and, consequently, a decrease in the well production. The most widely used breakers are oxidizers and enzymes. The breakers can be dissolved or suspended in the liquid (aqueous, non-aqueous or emulsion) phase of the treating fluid and exposed to the polymer throughout the treatment (added “internally”), or exposed to the fluid at some time after the treatment (added “externally”). Breaking can occur in the wellbore, gravel pack, filter cake, the rock matrix, in a fracture, or in another added or created environment. See, for example, U.S. Pat. No. 4,741,401 (Wailes et al.), assigned to Schlumberger Dowell and incorporated herein by reference, for a detailed discussion of breaking activities.

It has now been found that some components can act as both an early viscosity enhancer and a breaking agent for gelled oils.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In a first aspect of the disclosure, methods are provided including forming a gelled organic-based fluid by combining:

a. an organic solvent; b. an alkaline agent in the form of particles present in the gelled organic-based fluid in an amount from about 0.001 to about 0.02 pounds per gallon of the gelled organic-based fluid; c. a gelling agent; and d. a metal crosslinker; wherein the gelled organic-based fluid has a viscosity which is greater than a viscosity of an equivalent gelled organic-based fluid not including the alkaline agent.

In a second aspect of the disclosure, methods are provided including: i) forming a gelled organic-based fluid by combining:

a. an organic solvent; b. an alkaline agent in the form of particles present in the gelled organic-based fluid in an amount from about 0.001 to about 0.02 pounds per gallon of the gelled organic-based fluid; c. a gelling agent; and d. a metal crosslinker; ii) introducing the gelled organic-based fluid into a wellbore for contact with the subterranean formation and at a pressure above a fracturing pressure of the subterranean formation; wherein within 1 minute of introduction of the gelled organic-based fluid into the wellbore, the viscosity of the gelled organic-based fluid is at least about 300 cP.

### BRIEF DESCRIPTION OF THE DRAWINGS

FIG. 1 shows viscosity at 160 deg F. for samples of gelled oil fluids containing various amounts of MgO.

FIG. 2 shows viscosity at 160 deg F. for samples of gelled oil fluids containing various amounts of MgO.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

The following definitions are provided in order to aid those skilled in the art in understanding the detailed description of the invention.

Fluids and methods using fluids are based upon at least one organic base, such as a hydrocarbon fluid. As used herein, “organic solvent” includes, for example, any organic fluid medium suitable to facilitate ease of reaction and/or intermixing of the disclosed reactants, ease of handling of the disclosed reactants or resulting reaction products, and/or that may be optionally selected to be removable (e.g. by distillation) from a reaction product, following reaction. Organic solvents may be selected to have desired properties relative to the given reactants employed and may be chosen, for example, from any of the hydrocarbon or other organic fluids listed elsewhere herein as suitable for organic base fluids. When used, the hydrocarbon fluid comprises any known hydrocarbon liquid such as crude oil, refined or partially refined oil, fuel oil, liquefied gas, alkanes, alpha-olefins, internal olefins, diesel oil, condensates and combinations of hydrocarbons. In an embodiment the organic solvent is diesel. In other embodiments, diesel can be replaced with a number of other hydrocarbons and solvents: xylene, LPG, toluene, ether, ester, mineral oil, other petroleum distillates, vegetable oil, animal oil, bio-diesel, etc. As used herein, “fatty acid” is a carboxylic acid often with a long unbranched aliphatic tail chain. Fatty acids are aliphatic monocarboxylic acids derived from or contained in esterified form in an animal or vegetable fat, oil or wax. Aliphatics include alkanes (e.g. paraffin hydrocarbons), alkenes (e.g. ethylene) and alkynes (e.g. acetylene). Natural fatty acids commonly have a chain of 4 to 28 carbons (usually unbranched and even-numbered), which may be saturated or unsaturated.

The term “surfactant” refers to a soluble or partially soluble compound that reduces the surface tension of liquids, or reduces inter-facial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactant” or “YES” refers to that class of compounds which can form micelles (spherulitic, anisometric, lamellar, or liquid crystal) in the presence of counter ions in aqueous solutions, thereby imparting viscosity to the fluid. Anisometric micelles can be used, as their behavior in solution most closely resembles that of a polymer.

According to a first aspect, embodiments are disclosed where a method(s) comprise forming a gelled organic-based fluid by combining an organic solvent; an alkaline agent in the form of particles present in the gelled organic-based fluid in an amount from about 0.001 to about 0.02 or about 0.002 to about 0.015 or about 0.002 to about 0.006 pounds per gallon of the gelled organic-based fluid; a gelling agent; and a metal crosslinker. The alkaline agent in the form of particles can have a particle size of at least: about 0.5 or about 1 or about 2 or about 5 or about 10 or about 20 or about 50 μm. The thus formed gelled organic-based fluid has a viscosity which is greater than a viscosity of an equivalent gelled organic-based fluid not including the alkaline agent. According to an aspect, within about 1 or about 5 or about 10 or about 20 minutes of formation of the gelled organic-based fluid, the viscosity of the gelled organic-based fluid is at least about 25%, or at least about 50%, or at least about 100% higher than the viscosity of the equivalent gelled organic-based fluid not including the alkaline agent. According to an aspect, within about 1 or about 5 or about 10 or about 20 minutes of the formation of the gelled organic-based fluid, the viscosity of the gelled organic-based fluid is at least about 300 cP or at least about 400 cP, or at least about 450 cP or at least about 500 cP.

According to an aspect, the gelled organic-based fluid is introduced into a wellbore for contact with a subterranean formation and at a pressure above a fracturing pressure of the subterranean formation. The viscosity of the gelled organic-based fluid present in the subterranean formation is allowed to increase to a value greater than about 300 cP, or greater than about 400 cP, or greater than about 450 cP or greater than about 500 cP or greater than about 700 cP to form a high viscosity fluid; and the high viscosity fluid is contacted with a breaker compound comprising a second alkaline agent to break the high viscosity fluid to form a broken fluid having a viscosity less than about 100 cP or less than about 50 cP, or less than about 25 cP. In one aspect, prior to introduction of the gelled organic-based fluid into the wellbore, the gelled organic-based fluid comprises the breaker compound which is encapsulated. In one aspect, the step of contacting the high viscosity fluid with the breaker compound is done by introducing the breaker compound, encapsulated or not encapsulated, into the wellbore.

In one aspect, a method of treating a subterranean formation comprises:

i) forming a gelled organic-based fluid by combining:
a. the organic solvent as described herein;
b. the alkaline agent in the form of particles present in the gelled organic-based fluid in an amount from about 0.001 to about 0.02 or about 0.002 to about 0.015 or about 0.002 to about 0.006 pounds per gallon of the gelled organic-based fluid, as described herein;
c. the gelling agent, as described herein; and
d. the metal crosslinker, as described herein;
ii) introducing the gelled organic-based fluid into a wellbore for contact with the subterranean formation and at a pressure above a fracturing pressure of the subterranean formation; wherein within about 1 or about 5 or about 10 or about 20 minutes of introduction of the gelled organic-based fluid into the wellbore, the viscosity of the gelled organic-based fluid is at least about 300 cP, or at least about 400 cP, or at least about 450 cP or at least about 500 cP. In one aspect, the viscosity of the gelled organic-based fluid is allowed to increase to a value greater than about 300 cP, or greater than about 400 cP, or greater than about 450 cP or greater than about 500 cP or greater than about 700 cP to form a high viscosity fluid; and the high viscosity fluid is contacted with a breaker compound, as described herein, comprising the second alkaline agent, as described herein, to break the high viscosity fluid to form a broken fluid having a viscosity less than about 100 cP or less than about 50 cP, or less than about 25 cP.

The organic solvent may be any known component according to the definition above. In some embodiments the organic solvent is hydrocarbon liquid such as diesel oil, kerosene, paraffinic oil, crude oil, refined oil, gas-condensates, liquefied petroleum gas (LPG), alkanes, alpha-olefins, internal olefins, toluene, xylene, ethers, esters, mineral oil, biodiesel, vegetable oil, animal oil, alcohol, condensates, and mixtures thereof.

The alkaline agent and the second alkaline agent can be the same or different agents, and each independently can be an insoluble hydroxide or oxide of a Group 2 alkali earth metal; or each can be selected from the group consisting of MgO, MgOH, CaO, CaOH, and combinations thereof.

The gelling agent can be a phosphate ester. The phosphate ester may be an alkyl phosphate ester or an orthophosphate ester gelling agent. Such gelling agent is typically formed from a mixture of primary mono-hydric alcohols having carbon chains of from about 3 to about 18 carbon atoms. The alcohols are reacted with phosphates such as phosphorous pentoxide and/or trimethyl phosphate to produce mono-alkyl, di-alkyl, and/or tri-alkyl esters. These gelling agents are effective viscosifiers in a wide range of organic solvent types, and are most effective when neutralized (i.e., no excess presence of base or acid). Specific alkyl phosphate ester gelling agents include C3-18 (preferably C6-10) alkyl diester acids, C8-10 alkyl diester acid, mixtures of the above, and analogous mono and diesters. Such alkyl phosphate esters or diesters are typically prepared by reacting a C3-18 aliphatic alcohol with phosphorous pentoxide. The phosphate intermediate interchanges its ester groups with triethyl phosphate with triethylphosphate producing a more broad distribution of alkyl phosphate esters. Alternatively, the gelling agent may be made by admixing with an alkyl diester, a mixture of low molecular weight alkyl alcohols or diols. The low molecular weight alkyl alcohols or diols preferably include C6 to C10 alcohols or diols. The alcohol mixture, however, will contain from 0.05 to 5.0 wt % or from 0.1 to 3.0 wt % of the high molecular weight alcohol or diol. The low molecular weight alcohols (or diols) and the high molecular weight alcohols (or diols) may be added as a mixture or added separate in the production of the phosphate ester.

The crosslinker can be aluminum or ferric (iron) crosslinkers. Other types of metal crosslinker can be used, the metal being a multivalent metal such as boron, zinc, copper, iron, magnesium, calcium, barium, titanium, zirconium, tin, cobalt and so forth, and mixtures thereof, or a metal alkoxide, complexed to carboxylic acid groups.

When an aluminum crosslinker is used, examples of phosphate esters useful in forming the aluminum salts are 7,10-dioxadodecyl-y-oxanonyl phosphate; bis(7, 10-dioxadodecyl) phosphate; bis(7-oxanonyl) phosphate; 7-oxanonyl-2-oxabutyl phosphate; 5-oxanonyl-3-oxapentyl phosphate; 11-oxatridecyl phosphate; 5-oxaheptyl-9-oxaundecanyl phosphate; 13-methyl-11-oxatridecanyl phosphate; 11, 14-dimethyl 9, 12-dioxatetradecyl 4-oxahex-1-enyl phosphate; 4, 7-dioxanonyl-8-oxadecyl phosphate; 7-oxanonyl octyl phosphate; 6-oxaoctyl methyl phosphate; 5-methyl-7, 10-dioxadodecyl tetradecyl phosphate; 3-oxapentyl octyl phosphate; 6-butyl-12-methyl-10-oxadodecyl octyl phosphate; and 4-methyl-2-oxabutyl nonyl phosphate.

Some small amount of sodium hydroxide and water can be added to increase the pH to optimum gelling range at the time the aluminum compound is mixed. The final pH should be partially acidic. The phosphate ester and crosslinking agent at the proper pH react in the oil to gel the oil.

In most applications the concentration of the gelling agent will be from 0.05 to 4.0 wt %, or from 0.5 to 2.0 wt %, of the oil-base liquid.

In a second aspect, the gelled organic-based fluid can optionally further comprise a viscoelastic surfactant to gel sufficiently, or to have a sufficient increase in viscosity. The resultant combination is liquid. The gelled organic-based fluid may also contain in another embodiment gel stabilizers, including but not limited to a source of basic aluminum such as sodium aluminate, aluminum alkoxides or aluminum acetate to assist in formation of the gel structure.

The VES may be selected from the group consisting of cationic, anionic, zwitterionic, amphoteric, nonionic and combinations thereof. Some non-limiting examples are those cited in U.S. Pat. No. 6,435,277 (Qu et al.) and U.S. Pat. No. 6,703,352 (Dahayanake et al.), each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

Non-limiting examples of suitable viscoelastic surfactants useful for viscosifying some fluids include cationic surfactants, anionic surfactants, zwitterionic surfactants, amphoteric surfactants, nonionic surfactants, and combinations thereof.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and CH₂CH₂O may also be OCH₂CH₂.

In an embodiment, a zwitterionic surfactant of the family of betaine is used. Two suitable examples of betaines are BET-O and BET-E. The surfactant in BET-O-30 is shown below; one chemical name is oleylamidopropyl betaine. It is designated BET-O-30 because as obtained from the supplier (Rhodia, Inc. Cranbury, N.J., U.S.A) it is called Mirataine BET-O-30 because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. VES systems, in particular BET-E-40, optionally contain about 1% of a condensation product of a naphthalene sulfonic acid, for example sodium polynaphthalene sulfonate, as a rheology modifier, as described in U. S. Patent Application Publication No. 2003-0134751. The surfactant in BET-E-40 is also shown below; one chemical name is erucylamidopropyl betaine. As-received concentrates of BET-E-40 were used in the experiments reported below, where they will be referred to as “YES”. BET surfactants, and other VES's that are suitable, are described in U.S. Pat. No. 6,258,859. According to that patent, BET surfactants make viscoelastic gels when in the presence of certain organic acids, organic acid salts, or inorganic salts; in that patent, the inorganic salts were present at a weight concentration up to about 30%. Co-surfactants may be useful in extending the brine tolerance, and to increase the gel strength and to reduce the shear sensitivity of the VES-fluid, in particular for BET-O-type surfactants. An example given in U.S. Pat. No. 6,258,859 is sodium dodecylbenzene sulfonate (SDBS), also shown below. Other suitable co-surfactants include, for example those having the SDBS-like structure in which x=5-15; preferred co-surfactants are those in which x=7-15. Still other suitable co-surfactants for BET-O-30 are certain chelating agents such as trisodium hydroxyethylethylenediamine triacetate. The rheology enhancers may be used with viscoelastic surfactant fluid systems that contain such additives as co-surfactants, organic acids, organic acid salts, and/or inorganic salts.

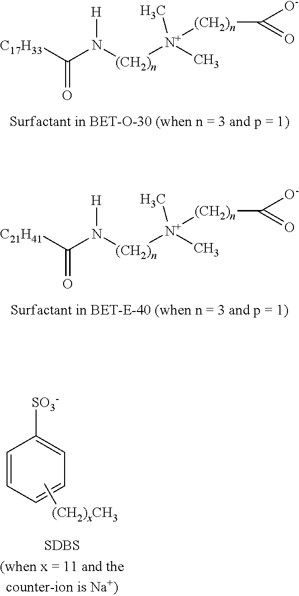

Some embodiments use betaines; most preferred use BET-E-40. Although experiments have not been performed, it is believed that mixtures of betaines, especially BET-E-40, with other surfactants are also suitable. Such mixtures are within the scope of embodiments.

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. More preferred betaines are those in which the alkene side chain contains 17-21 carbon atoms (not counting the carbonyl carbon atom) which may be branched or straight chained and which may be saturated or unsaturated, n=3-5, and p=1-3, and mixtures of these compounds. These surfactants are used at a concentration of about 0.5 to about 10%, preferably from about 1 to about 5%, and most preferably from about 1.5 to about 4.5%.

Exemplary cationic viscoelastic surfactants include the amine salts and quaternary amine salts disclosed in U.S. Pat. Nos. 5,979,557, and 6,435,277 which have a common Assignee as the present application and which are hereby incorporated by reference. Examples of suitable cationic viscoelastic surfactants include cationic surfactants having the structure:

R₁N⁺(R₂)(R₃)(R₄) X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄) X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in U.S. Pat. No. 7,084,095 which is hereby incorporated by reference.

Another suitable cationic VES is erucyl bis(2-hydroxyethyl) methyl ammonium chloride, also known as (Z)-13 docosenyl-N-N-bis (2-hydroxyethyl) methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with viscoelastic surfactant, for example those containing cationic surfactants having structures similar to that of erucyl bis(2-hydroxyethyl) methyl ammonium chloride, inherently have short re-heal times and the rheology enhancers may not be needed except under special circumstances, for example at very low temperature.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant may also be based upon any suitable anionic surfactant. In some embodiments, the anionic surfactant is an alkyl sarcosinate. The alkyl sarcosinate can generally have any number of carbon atoms. Presently preferred alkyl sarcosinates have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

The gelled organic-based fluid may also typically contain proppants. The selection of a proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated, provided that the resin and any other chemicals that might be released from the coating or come in contact with the other chemicals are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U. S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L. The fluid may also contain other enhancers or additives.

In some embodiments, the gelled organic-based fluid may optionally comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the composition using a gas, such as air, nitrogen, or carbon dioxide. In one certain embodiment, the composition may contain a particulate additive, such as a particulate scale inhibitor.

The gelled organic-based fluid may be used, for example in oilfield treatments. The fluids may also be used in other industries, such as in household and industrial cleaners, agricultural chemicals, personal hygiene products, cosmetics, pharmaceuticals, printing and in other fields.

The gelled organic-based fluid may be used for carrying out a variety of subterranean treatments, where a viscosified treatment fluid may be used, including, but not limited to, drilling operations, fracturing treatments, and completion operations (e.g., gravel packing). In some embodiments, the gelled organic-based fluid may be used in treating a portion of a subterranean formation. In certain embodiments, the gelled organic-based fluid systems may be introduced into a well bore that penetrates the subterranean formation. Optionally, the gelled organic-based fluid systems further may comprise particulates and other additives suitable for treating the subterranean formation. For example, the gelled organic-based fluid systems may be allowed to contact the subterranean formation for a period of time sufficient to reduce the viscosity of the treatment fluid. In some embodiments, the gelled organic-based fluid systems may be allowed to contact hydrocarbons, formations fluids, and/or subsequently injected treatment fluids, thereby reducing the viscosity of the treatment fluid. After a chosen time, the gelled organic-based fluid systems may be broken by any means known by those skilled in the art, such as introduction of the second alkaline agent as described herein. And after another chosen time, the gelled organic-based fluid systems may be recovered through the well bore.

In certain embodiments, the gelled organic-based fluid systems may be used in fracturing treatments. In the fracturing embodiments, the composition may be introduced into a well bore that penetrates a subterranean formation at or above a pressure sufficient to create or enhance one or more fractures in a portion of the subterranean formation (fracturing pressure). Generally, in the fracturing embodiments, the gelled organic-based fluid systems may exhibit viscoelastic behavior if a VES is used. Optionally, the gelled organic-based fluid systems further may comprise particulates and other additives suitable for the fracturing treatment. After a chosen time, the gelled organic-based fluid systems may be broken by any means known by those skilled in the art, such as introduction of the second alkaline agent as described herein. And after another chosen time, the gelled organic-based fluid systems may be recovered through the well bore.

The gelled organic-based fluid systems are also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

To facilitate a better understanding of the embodiments disclosed herewith, the following examples are given. In no way should the following examples be read to limit, or define, the scope of the invention.

### EXAMPLES

For Examples 1 and 2 below, a series of experiments were conducted to demonstrate viscosity increases of gelled organic-based fluid systems by introduction of MgO.

### Example 1

Gelled organic-based fluids were prepared by adding the following components to a hydrotreated light petroleum distillates base-oil containing 0.5 wt % or less aromatics:

5 GPT (gallons per thousand gallons) of compound A containing 10-30 wt % aluminum chloride;
5 GPT of compound B containing 60-100 wt % alkyl phosphate esters; and
varying GPT's (0, 3 and 4) of compound C comprising 17.5 wt % MgO.

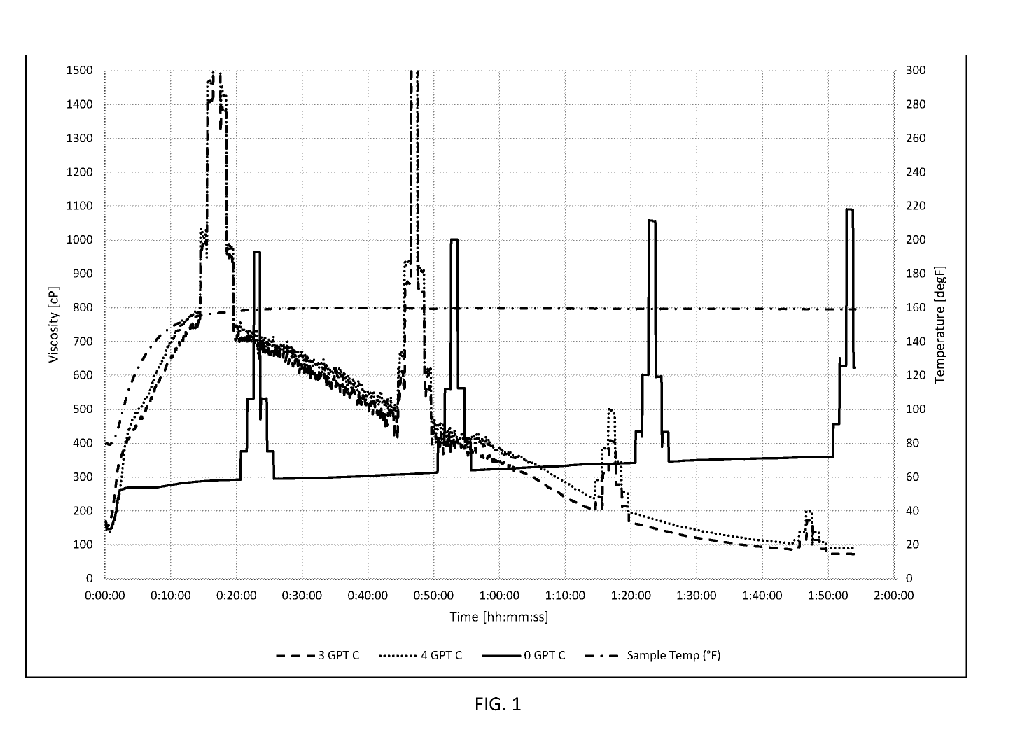

The viscosity for the prepared fluids was measured over a period of time with a Chandler 5550 HPHT rheometer following the API RP 13M shear ramp schedule. API RP 13M has a series of shear ramps (100 s⁻¹, 75 s⁻¹, 50 s⁻¹, and 25 s⁻¹) that aid in determining fluid properties such as n′ and k′. FIG. 1 shows the results of the rheological testing, and demonstrates early viscosity enhancement with the presence of MgO in the gelled oil fluid, but still breaking the fluid over time.

### Example 2

Gelled organic-based fluids were prepared by adding the following components to a hydrotreated light petroleum distillates base-oil containing 0.5 wt % or less aromatics:

4 GPT (gallons per thousand gallons) of compound A containing 10-30 wt % aluminum chloride;
4 GPT of compound B containing 60-100 wt % alkyl phosphate esters; and
varying GPT's (0, 2 and 4) of compound C comprising 17.5 wt % MgO.

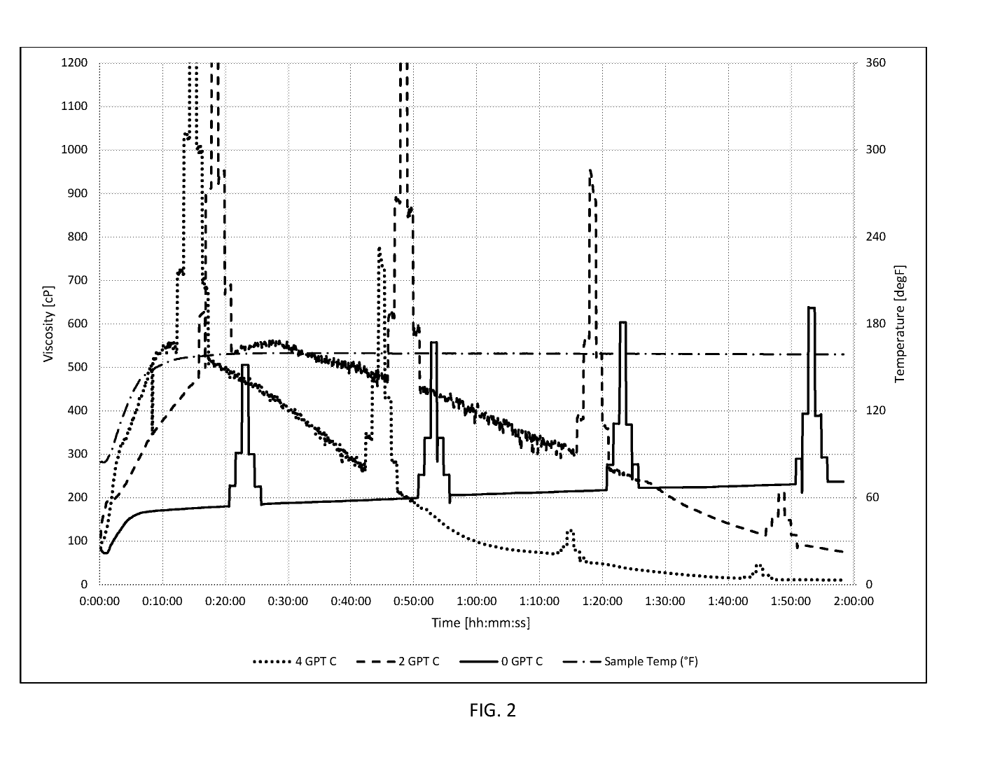

The viscosity for the prepared fluids was measured over a period of time with a Chandler 5550 HPHT rheometer following the API RP 13M shear ramp schedule. API RP 13M has a series of shear ramps (100 s⁻¹, 75 s⁻¹, 50 s⁻¹, and 25 s⁻¹) that aid in determining fluid properties such as n′ and k′. FIG. 2 shows the results of the rheological testing, and demonstrates early viscosity enhancement with the presence of MgO in the gelled oil fluid, but still breaking the fluid over time.

The foregoing disclosure and description of the embodiments is illustrative and explanatory thereof and it can be readily appreciated by those skilled in the art that various changes in the size, shape and materials, as well as in the details of the illustrated construction or combinations of the elements described herein can be made without departing from the scope of the claims.

We claim:

1. A method comprising:
forming a gelled organic-based fluid by combining:
a. an organic solvent;
b. an alkaline agent in the form of particles present in the gelled organic-based fluid in an amount from about 0.001 to about 0.02 pounds per gallon of the gelled organic-based fluid;
c. a gelling agent; and
d. a metal crosslinker;
wherein the gelled organic-based fluid has a viscosity which is greater than a viscosity of an equivalent gelled organic-based fluid not including the alkaline agent.

2. The method of claim 1 wherein within about 1 min of formation of the gelled organic-based fluid, the viscosity of the gelled organic-based fluid is at least about 25% higher than the viscosity of the equivalent gelled organic-based fluid not including the alkaline agent.

3. The method of claim 1 wherein within about 1 hour of the formation of the gelled organic-based fluid, the viscosity of the gelled organic-based fluid is at least about 300 cP.

4. The method of claim 1 wherein the gelled organic-based fluid is introduced into a wellbore for contact with a subterranean formation and at a pressure above a fracturing pressure of the subterranean formation.

5. The method of claim 4 wherein the viscosity of the gelled organic-based fluid is allowed to increase to a value greater than about 300 cP to form a high viscosity fluid; and wherein the high viscosity fluid is contacted with a breaker compound comprising a second alkaline agent to break the high viscosity fluid to form a broken fluid having a viscosity less than about 100 cP.

6. The method of claim 5, wherein, prior to introduction into the wellbore, the gelled organic-based fluid comprises the breaker compound which is encapsulated.

7. The method of claim 1, wherein the organic solvent is selected from the group consisting of diesel oil, kerosene, paraffinic oil, crude oil, refined oil, gas-condensates, liquefied petroleum gas (LPG), alkanes, alpha-olefins, internal olefins, toluene, xylene, ethers, esters, mineral oil, biodiesel, vegetable oil, animal oil, alcohol, condensates, and mixtures thereof.

8. The method of claim 1, wherein the gelling agent is a phosphate ester.

9. The method of claim 1, wherein the metal crosslinker is an aluminum or iron crosslinking agent.

10. The method of claim 1 wherein the alkaline agent is an insoluble hydroxide or oxide of a Group 2 alkali earth metal.

11. The method of claim 1 wherein the alkaline agent is selected from the group consisting of MgO, MgOH, CaO, CaOH, and combinations thereof.

12. A method of treating a subterranean formation, comprising:
i) forming a gelled organic-based fluid by combining:
a. an organic solvent;
b. an alkaline agent in the form of particles present in the gelled organic-based fluid in an amount from about 0.001 to about 0.02 pounds per gallon of the gelled organic-based fluid;
c. a gelling agent; and
d. a metal crosslinker;
ii) introducing the gelled organic-based fluid into a wellbore for contact with the subterranean formation and at a pressure above a fracturing pressure of the subterranean formation;
wherein within about 1 minute of introduction of the gelled organic-based fluid into the wellbore, the viscosity of the gelled organic-based fluid is at least about 300 cP.

13. The method of claim 12 wherein the viscosity of the gelled organic-based fluid is allowed to increase to a value greater than about 300 cP to form a high viscosity fluid; and wherein the high viscosity fluid is contacted with a breaker compound comprising a second alkaline agent to break the high viscosity fluid to form a broken fluid having a viscosity less than about 100 cP.

14. The method of claim 13, wherein, prior to introduction into the wellbore, the gelled organic-based fluid comprises the breaker compound which is encapsulated.

15. The method of claim 13, wherein the step of contacting the high viscosity fluid with the breaker compound is done by introducing the breaker compound into the wellbore.

16. The method of claim 12, wherein the organic solvent is selected from the group consisting of diesel oil, kerosene, paraffinic oil, crude oil, refined oil, gas-condensates, liquefied petroleum gas (LPG), alkanes, alpha-olefins, internal olefins, toluene, xylene, ethers, esters, mineral oil, biodiesel, vegetable oil, animal oil, alcohol, condensates, and mixtures thereof.

17. The method of claim 12, wherein the gelling agent is a phosphate ester.

18. The method of claim 12, wherein the metal crosslinker is an aluminum or iron crosslinking agent.

19. The method of claim 12 wherein the alkaline agent is an insoluble hydroxide or oxide of a Group 2 alkali earth metal.

20. The method of claim 12, further comprising introducing proppant into the well.
